(19) United States
(12) Patent Application Publication
(10) Pub. No.: US 2025/0081015 A1
(43) Pub. Date: Mar. 6, 2025

(54) ENHANCED NON-LINEARITY CORRECTION BASED ON STATISTICAL MOMENTS

(71) Applicant: QUALCOMM Incorporated, San Diego, CA (US)

(72) Inventors: Amit MOSES, Tel Aviv (IL); Ronen SHAKED, Kfar Saba (IL); Aviv REGEV, Tel Aviv (IL); Elad MEIR, Ramat Gan (IL); Yaniv EISTEIN, Tel Aviv (IL)

(21) Appl. No.: 18/458,932

(22) Filed: Aug. 30, 2023

(51) Int. Cl. H04W 24/10; H04W 8/24; H04W 76/10

(52) U.S. Cl. CPC H04W 24/10; H04W 8/24; H04W 76/10

(57) ABSTRACT

Methods, systems, and devices for wireless communications are described. A second wireless device may perform an enhanced non-linearity correction procedure. For example, the second wireless device may transmit, to a first wireless device, a capability report and, additionally, or alternatively, a request for a statistical attribute report associated with a power amplifier (PA) of the first wireless device. The statistical attribute report may include one or more statistical attributes associated with one or more PA coefficients for the PA. The second wireless device may receive, in response to the request, the statistical attribute report and a data signal based on the one or more PA coefficients for the PA from the first wireless device. The second wireless device may perform, based on the statistical attribute report and the data signal, an enhanced non-linearity correction procedure on the data signal.

### FIELD OF TECHNOLOGY

The following relates to wireless communications, including enhanced non-linearity correction based on statistical moments.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support enhanced non-linearity correction based on statistical moments. For example, the described techniques provide an enhanced non-linearity correction procedure that may correct non-linearity corrupting errors using a relatively reduced quantity of calculations for a set of demodulated slots (e.g., relative to other correction procedures). A wireless device implementing the enhanced non-linearity correction procedure described herein may therefore correct such errors without suffering performance degradation, particularly in cases with relatively low signal-to-noise ratios (SNRs) or signal-to-interference-plus-noise ratios (SINRs). A transmitter (e.g., a first wireless device, such as a network entity) may calculate statistical attributes (e.g., a mean and a variance) of power amplifier (PA) coefficients associated with a PA of the transmitter. In some examples, a receiver (e.g., a second wireless device, such as a user equipment (UE)) may transmit a capability report indicating that the receiver is capable of performing the enhanced non-linearity correction and indicating a request for a statistical attribute report including the calculated statistical attributes. The transmitter may transmit, to the receiver, the statistical attribute report and a data signal that has been amplified by the associated PA. The receiver may perform the enhanced non-linearity correction on the data signal to estimate the PA coefficients according to a periodicity and using the statistical attributes included in the statistical attribute report. The enhanced non-linearity correction may use a linear minimum mean square error (LMMSE) method, which may improve performance in cases of low SNR and reduce overhead when compared to a least squares (LS) method.

A method for wireless communications by a first wireless device is described. The method may include receiving, from a second wireless device, a request for a statistical attribute report associated with a PA of the first wireless device, transmitting, in response to the request, the statistical attribute report to the second wireless device, where the statistical attribute report includes one or more statistical attributes associated with one or more PA coefficients for the PA of the first wireless device, and transmitting, to the second wireless device, a data signal based on the one or more PA coefficients for the PA.

A first wireless device for wireless communications is described. The first wireless device may include one or more memories storing processor executable code, and one or more processors coupled with the one or more memories. The one or more processors may individually or collectively operable to execute the code to cause the first wireless device to receive, from a second wireless device, a request for a statistical attribute report associated with a PA of the first wireless device, transmit, in response to the request, the statistical attribute report to the second wireless device, where the statistical attribute report includes one or more statistical attributes associated with one or more PA coefficients for the PA of the first wireless device, and transmit, to the second wireless device, a data signal based on the one or more PA coefficients for the PA.

Another first wireless device for wireless communications is described. The first wireless device may include means for receiving, from a second wireless device, a request for a statistical attribute report associated with a PA of the first wireless device, means for transmitting, in response to the request, the statistical attribute report to the second wireless device, where the statistical attribute report includes one or more statistical attributes associated with one or more PA coefficients for the PA of the first wireless device, and means for transmitting, to the second wireless device, a data signal based on the one or more PA coefficients for the PA.

A non-transitory computer-readable medium storing code for wireless communications is described. The code may include instructions executable by a processor to receive, from a second wireless device, a request for a statistical attribute report associated with a PA of the first wireless device, transmit, in response to the request, the statistical attribute report to the second wireless device, where the statistical attribute report includes one or more statistical attributes associated with one or more PA coefficients for the PA of the first wireless device, and transmit, to the second wireless device, a data signal based on the one or more PA coefficients for the PA.

Some examples of the method, first wireless devices, and non-transitory computer-readable medium described herein may further include operations, features, means, or instructions for receiving, from the second wireless device, a capability report indicating that the second wireless device may be capable of performing an enhanced non-linearity correction, the statistical attribute report may be transmitted based on the capability report.

In some examples of the method, first wireless devices, and non-transitory computer-readable medium described herein, transmitting the statistical attribute report may include operations, features, means, or instructions for transmitting the statistical attribute report in accordance with a quantity of antennas at the first wireless device, where the one or more statistical attributes include a quantity of statistical attributes that may be based on the quantity of antennas.

In some examples of the method, first wireless devices, and non-transitory computer-readable medium described herein, transmitting the statistical attribute report may include operations, features, means, or instructions for transmitting, in the statistical attribute report, one or more second statistical attributes associated with one or more second PA coefficients for a second PA of the first wireless device.

In some examples of the method, first wireless devices, and non-transitory computer-readable medium described herein, the PA corresponds to a first transmit chain and the second PA corresponds to a second transmit chain.

In some examples of the method, first wireless devices, and non-transitory computer-readable medium described herein, the PA corresponds to a portion of a set of multiple antennas of the first wireless device.

In some examples of the method, first wireless devices, and non-transitory computer-readable medium described herein, the one or more statistical attributes include a mean associated with the one or more PA coefficients and a variance associated with the one or more PA coefficients.

Some examples of the method, first wireless devices, and non-transitory computer-readable medium described herein may further include operations, features, means, or instructions for establishing a connection with the second wireless device, where transmitting the statistical attribute report may be based on establishing the connection.

Some examples of the method, first wireless devices, and non-transitory computer-readable medium described herein may further include operations, features, means, or instructions for determining the one or more statistical attributes associated with the one or more PA coefficients for the PA of the first wireless device.

In some examples of the method, first wireless devices, and non-transitory computer-readable medium described herein, transmitting the statistical attribute report may include operations, features, means, or instructions for transmitting the statistical attribute report via a medium access control-control element (MAC-CE), a radio resource control (RRC) message, a physical downlink control channel (PDCCH), a physical downlink shared channel (PDSCH), or a combination thereof.

A method for wireless communications by a second wireless device is described. The method may include transmitting, to a first wireless device, a request for a statistical attribute report associated with a PA of the first wireless device, receiving, in response to the request, the statistical attribute report from the first wireless device, where the statistical attribute report includes one or more statistical attributes associated with one or more PA coefficients for the PA, receiving, from the first wireless device, a data signal based on the one or more PA coefficients for the PA, and performing, based on the statistical attribute report and the data signal, an enhanced non-linearity correction procedure on the data signal.

A second wireless device for wireless communications is described. The second wireless device may include one or more memories storing processor executable code, and one or more processors coupled with the one or more memories. The one or more processors may individually or collectively operable to execute the code to cause the second wireless device to transmit, to a first wireless device, a request for a statistical attribute report associated with a PA of the first wireless device, receive, in response to the request, the statistical attribute report from the first wireless device, where the statistical attribute report includes one or more statistical attributes associated with one or more PA coefficients for the PA, receive, from the first wireless device, a data signal based on the one or more PA coefficients for the PA, and perform, based on the statistical attribute report and the data signal, an enhanced non-linearity correction procedure on the data signal.

Another second wireless device for wireless communications is described. The second wireless device may include means for transmitting, to a first wireless device, a request for a statistical attribute report associated with a PA of the first wireless device, means for receiving, in response to the request, the statistical attribute report from the first wireless device, where the statistical attribute report includes one or more statistical attributes associated with one or more PA coefficients for the PA, means for receiving, from the first wireless device, a data signal based on the one or more PA coefficients for the PA, and means for performing, based on the statistical attribute report and the data signal, an enhanced non-linearity correction procedure on the data signal.

A non-transitory computer-readable medium storing code for wireless communications is described. The code may include instructions executable by a processor to transmit, to a first wireless device, a request for a statistical attribute report associated with a PA of the first wireless device, receive, in response to the request, the statistical attribute report from the first wireless device, where the statistical attribute report includes one or more statistical attributes associated with one or more PA coefficients for the PA, receive, from the first wireless device, a data signal based on the one or more PA coefficients for the PA, and perform, based on the statistical attribute report and the data signal, an enhanced non-linearity correction procedure on the data signal.

Some examples of the method, second wireless devices, and non-transitory computer-readable medium described herein may further include operations, features, means, or instructions for transmitting, to the first wireless device, a capability report indicating that the second wireless device may be capable of performing an enhanced non-linearity correction, the statistical attribute report may be received based on the capability report.

In some examples of the method, second wireless devices, and non-transitory computer-readable medium described herein, performing the enhanced non-linearity correction procedure may include operations, features, means, or instructions for performing the enhanced non-linearity correction procedure according to a periodicity associated with a period.

In some examples of the method, second wireless devices, and non-transitory computer-readable medium described herein, performing the enhanced non-linearity correction procedure may include operations, features, means, or instructions for performing the enhanced non-linearity correction procedure for a first slot in the period.

In some examples of the method, second wireless devices, and non-transitory computer-readable medium described herein, performing the enhanced non-linearity correction procedure for the first slot in the period may include operations, features, means, or instructions for applying a result of the enhanced non-linearity correction procedure for the first slot in the period to a set of remaining slots in the period.

In some examples of the method, second wireless devices, and non-transitory computer-readable medium described herein, the enhanced non-linearity correction procedure may be based on linear minimum mean square error.

In some examples of the method, second wireless devices, and non-transitory computer-readable medium described herein, the enhanced non-linearity correction procedure may be a digital post-distortion (DPOD) correction.

In some examples of the method, second wireless devices, and non-transitory computer-readable medium described herein, receiving the statistical attribute report may include operations, features, means, or instructions for receiving the statistical attribute report in accordance with a quantity of antennas at the first wireless device, where the one or more statistical attributes include a quantity of statistical attributes that may be based on the quantity of antennas.

In some examples of the method, second wireless devices, and non-transitory computer-readable medium described herein, the one or more statistical attributes includes a mean associated with the one or more PA coefficients and a variance associated with the one or more PA coefficients.

Some examples of the method, second wireless devices, and non-transitory computer-readable medium described herein may further include operations, features, means, or instructions for establishing a connection with the first wireless device, where receiving the statistical attribute report may be based on establishing the connection.

In some examples of the method, second wireless devices, and non-transitory computer-readable medium described herein, receiving the statistical attribute report may include operations, features, means, or instructions for receiving the statistical attribute report via a MAC-CE, a RRC message, a PDCCH, a PDSCH, or a combination thereof.

### BRIEF DESCRIPTION OF THE DRAWINGS

FIG. 1 shows an example of a wireless communications system that supports enhanced non-linearity correction based on statistical moments in accordance with one or more aspects of the present disclosure.

FIG. 2 shows an example of a wireless communications system that supports enhanced non-linearity correction based on statistical moments in accordance with one or more aspects of the present disclosure.

FIGS. 3A and 3B show examples of resource diagrams that support enhanced non-linearity correction based on statistical moments in accordance with one or more aspects of the present disclosure.

FIG. 4 shows an example of a process flow that supports enhanced non-linearity correction based on statistical moments in accordance with one or more aspects of the present disclosure.

FIGS. 5 and 6 show block diagrams of devices that support enhanced non-linearity correction based on statistical moments in accordance with one or more aspects of the present disclosure.

FIG. 7 shows a block diagram of a communications manager that supports enhanced non-linearity correction based on statistical moments in accordance with one or more aspects of the present disclosure.

FIG. 8 shows a diagram of a system including a device that supports enhanced non-linearity correction based on statistical moments in accordance with one or more aspects of the present disclosure.

FIGS. 9 and 10 show block diagrams of devices that support enhanced non-linearity correction based on statistical moments in accordance with one or more aspects of the present disclosure.

FIG. 11 shows a block diagram of a communications manager that supports enhanced non-linearity correction based on statistical moments in accordance with one or more aspects of the present disclosure.

FIG. 12 shows a diagram of a system including a device that supports enhanced non-linearity correction based on statistical moments in accordance with one or more aspects of the present disclosure.

FIGS. 13 through 17 show flowcharts illustrating methods that support enhanced non-linearity correction based on statistical moments in accordance with one or more aspects of the present disclosure.

### DETAILED DESCRIPTION

A wireless communications system may support communications between a first wireless device (e.g., a user equipment (UE)) and a second wireless device (e.g., a network entity). For example, the network may use a radio frequency (RF) chain including one or more RF chain components, such as a power amplifier (PA), to transmit a downlink signal to the UE (e.g., via a downlink channel). A PA operate a given power level and thus may consume a given amount of power over time (e at the network entity, particularly at higher bandwidths (e.g., a bandwidth of 10 gigahertz (GHz) in sub-terahertz (sub-THz) frequency bands), which may exceed a threshold power level or power consumption. One PA design reduces the PA supply voltage to drop (e.g., lower, reduce) PA power consumption, but may add non-linearity corrupting errors to the transmitted signal. Such errors may arise due to a transfer function of the PA, such as a difference between the PA supply voltage and an envelope of an RF output voltage (e.g., amplitude modulation (AM) to AM (AM-AM) distortions), or an unwanted phase modulation of an RF output carrier (e.g., AM to phase modulation (PM) distortions). A UE (e.g., a next-generation 5G UE or 6G and beyond UE) may mitigate this impairment by performing a non-linearity correction procedure (e.g., a digital post-distortion (DPOD) correction) on the received downlink signal.

To perform a DPOD correction, the UE may estimate a PA model (e.g., a PA coefficients model) iteratively with the downlink channel, assisted by pilot signals (e.g., demodulation reference signals (DMRSs)). The UE may reconstruct an estimated distortion by applying the estimated PA model on hard decisions on received equalized data. The DPOD correction may include a data processing stage at which data (e.g., physical downlink shared channel (PDSCH) data) is corrected by subtracting the estimated distortion. However, performing the DPOD correction process on the DMRS and PDSCH may increase complexity (e.g., which may increase hardware costs) and increased latency for every demodulated slot.

The techniques described herein describe an enhanced non-linearity correction procedure based on statistical moments. The enhanced non-linearity correction procedure may take advantage of the property that a non-linear model varies relatively slowly over time, thereby avoiding performing high-complexity processes on a per-slot basis. For example, while a wireless channel may change at a relatively high rate (e.g., every slot), a non-linear PA model may change relatively slowly (e.g., periodically, with a period greater than one slot, or once in every N slots). Thus, the UE may estimate the PA model periodically rather than in every slot, which may reduce power consumption and latency at the UE without degrading performance. For example, a UE with a typical DPOD demodulator that uses a least squares (LS) method may estimate the PA coefficients every time slot in order to generate an equivalent PA transfer function at the UE, and estimating the PA model less frequently than once per slot may incur performance loss (e.g., a degraded error vector magnitude (EVM)) in low signal-to-noise ratio (SNR) or signal-to-interference-plus-noise (SINR) scenarios, even if the coefficients do not change much from slot to slot. In contrast, the enhanced non-linearity correction procedure described herein may provide relatively reduced performance loss (e.g., no performance loss) when activated periodically (e.g., once in every N slots).

For example, the enhanced non-linearity correction procedure performed at a receiver (e.g., the UE) may employ a PA coefficients estimator based on a linear minimum mean square error (LMMSE) method, which may use statistical metrics from a transmitter (e.g., the network entity). For example, the network entity may determine one or more statistical attributes (e.g., a mean, a variance) for one or more PA coefficients associated with one or more PAs of one or more RF chains of the network entity. In some examples, the UE may transmit a capability message to the network entity indicating that the UE is capable of performing the enhanced non-linearity correction procedure. Additionally, or alternatively, the UE may transmit a request for a statistical attribute report to the network entity. The network entity may transmit (e.g., based on or in response to the statistical attribute report request) a statistical attribute report including the one or more statistical attributes for one or more PAs. In some examples, the network entity may transmit a data signal to the UE using the RF chain and the one or more PAs associated with the statistical attributes included in the statistical attribute report. In some examples, the UE may perform the enhanced non-linearity correction procedure (e.g., based on LMMSE rather than LS) on the data signal with a periodicity greater than one slot.

The techniques described herein may reduce power consumption (e.g., improve power efficiency) at a first wireless device (e.g., a network entity) while maintaining performance and reducing a complexity, costs, and associated latency (e.g., through decimation, reducing the PA model estimation rate, or performing a PA model estimation periodically rather than at every slot), even in low SNR scenarios. Additionally, or alternatively, the use of an LMMSE estimator in the enhanced non-linearity correction procedure may achieve a given estimation accuracy with fewer pilots (e.g., DMRS) compared to an LS estimator, thereby reducing signaling overhead. For example, the enhanced non-linearity correction procedure (e.g., using LMMSE) may achieve higher accuracy estimation in low SNR scenarios than a typical non-linearity correction procedure (e.g., using LS).

Aspects of the disclosure are initially described in the context of wireless communications systems. Aspects of the disclosure are then described in the context of resource diagrams and a process flow. Aspects of the disclosure are further illustrated by and described with reference to apparatus diagrams, system diagrams, and flowcharts that relate to enhanced non-linearity correction based on statistical moments.

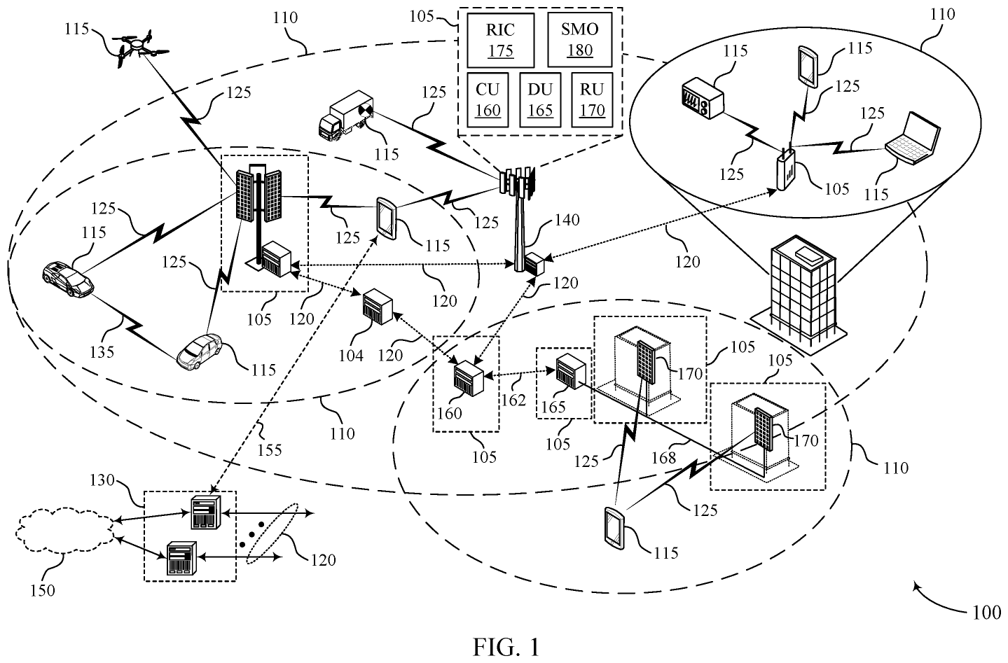

FIG. 1 shows an example of a wireless communications system 100 that supports enhanced non-linearity correction based on statistical moments in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., an RF access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support enhanced non-linearity correction based on statistical moments as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 GHz. Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

Devices in the wireless communications system 100 may support an enhanced non-linearity correction procedure based on statistical moments (e.g., statistical attributes, statistical values) as described herein. For example, a network entity 105 may determine one or more statistical attributes (e.g., a mean, a variance) of one or more PA coefficients associated with one or more PAs of one or more RF chains of the network entity 105. In some examples, a UE 115 may transmit a capability message to the network entity 105 indicating that the UE 115 is capable of performing the enhanced non-linearity correction procedure. Additionally, or alternatively, the UE 115 may transmit a statistical attribute report request to the network entity 105. The network entity 105 may transmit (e.g., based on or in response to the statistical attribute report request) a statistical attribute report including the one or more statistical attributes. In some examples, the network entity 105 may transmit a data signal to the UE 115 (e.g., via a communication link 125) using an RF chain of the one or more RF chains and the one or more PAs associated with the statistical attributes included in the statistical attribute report. The UE 115 may perform the enhanced non-linearity correction procedure (e.g., based on LMMSE rather than LS) on the data signal based on the statistical attribute report. In some cases, the UE 115 may perform the enhanced non-linearity correction procedure according to a periodicity greater than one slot.

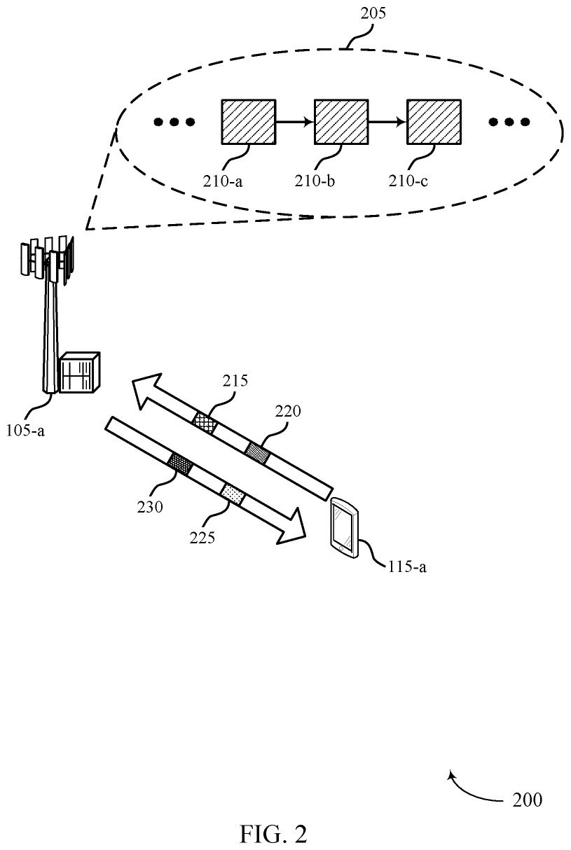

FIG. 2 shows an example of a wireless communications system 200 that supports enhanced non-linearity correction based on statistical moments in accordance with one or more aspects of the present disclosure. In some examples, wireless communications system 200 may implement aspects of wireless communications system 100. For example, wireless communications system 200 includes a UE 115-a and a network entity 105-a, which may be examples of the corresponding devices described with reference to FIG. 1. Additionally, or alternatively, the UE 115-a and the network entity 105-a may each be examples of other types of wireless devices, such as an IAB node or another type of transmitter or receiver. Thus, although aspects of the present disclosure are described with reference to a UE 115 and a network entity 105, it is understood that the described techniques may be performed by a wireless device different from a UE 115 and a network entity 105. As described herein, operations performed by the UE 115-a and the network entity 105-a may be respectively performed by a UE 115, a network entity 105, or another wireless device, and the examples shown should not be construed as limiting.

Devices in the wireless communications system 200 may support one or more RF chains, such as an RF chain 205 (e.g., a transmit (Tx) chain) at the network entity 105-a for transmissions from the network entity 105-a (e.g., to the UE 115-a). The RF chain 205 may include one or more RF chain components 210, such as RF chain components 210-a, 210-b, and 210-c. The one or more RF chain components 210 may include one or more amplifiers (e.g., PAs, low-noise amplifiers (LNAs), low phase noise amplifiers (LPNAs), bidirectional amplifiers (BDAs), broadband amplifiers (BAs), or wideband amplifiers (WBAs)), attenuators, switches, detectors, synthesizers, analog-to-digital converters (ADCs), digital-to-analog converters (DACs), other RF analog parts, or any combination thereof. In some examples, at least one of the RF chain components 210 in the RF chain 205, such as the RF chain component 210-c, may be a PA. Each PA associated with the RF chain 205 may be associated with one or more PA coefficients.

A PA (e.g., the RF chain component 210-c) provides gain to signals intended to be transmitted at relatively high power levels. That is, a wireless device (e.g., the network entity 105-a) may utilize a PA to convert a low-power RF signal into a relatively higher-power RF signal for transmission. A PA may be a significant consumer of power at the network entity 105-a, and reducing power consumption at the PA may be advantageous, for example in next generation (e.g., 6G and beyond) systems or at relatively high bandwidths (e.g., a bandwidth of 10 GHz in sub-THz frequency ranges). Reducing the PA supply voltage may reduce power consumption at the PA, but incurs a penalty of a poorer linearity region and introduces non-linearity corrupting errors to a transmitted signals due to associated PA transfer functions (e.g., AM/AM and AM/PM distortions). In conventional procedures, a receiving device (e.g., the UE 115-a) may perform a DPOD process to correct these errors on a received signal, but the DPOD process may be relatively complex and may need to be performed for (e.g., in) every slot of the received signal, which may introduce additional latency.

According to the techniques described herein, receiving devices (e.g., the UE 115-a) may account for such errors by implementing an enhanced non-linearity correction procedure. An enhanced non-linearity correction procedure may be performed by a receiving device, such as the UE 115-a, for a signal (e.g., a data signal 230) received from a transmitting device, such as the network entity 105-a. To successfully decode the signal, the UE 115-a may determine a model (e.g., a PA model) that approximates a PA transfer function associated with a PA used by the network entity 105-a to transmit the signal. More specifically, the UE 115-a may estimate PA coefficients of the PA transfer function to correct errors or other distortions in the signal that are due to power consumption reduction techniques implemented at the network entity 105-a. The network entity 105-a may be aware of the PA coefficients for the PA transfer function associated with the PA used to transmit the signal. As such, the network entity 105-a may provide information related to the PA(s) of the network entity 105-a to assist the UE 115-a with the enhanced non-linearity correction procedure.

This information may include or be an example of one or more statistical attributes associated with the PA and may enable the UE 115-a to accurately correct errors in the signal. Because the PA transfer function is non-linear and varies relatively slowly with time, the UE 115-a may utilize the one or more statistical attributes indicated by the network entity 105-a to perform the enhanced non-linearity correction procedure at a rate that is less than every slot of the signal. That is, the UE 115-a may perform the enhanced non-linearity correction procedure less often than a conventional DPOD process (e.g., every N slots rather than every slot), thereby performing fewer overall calculations compared to the conventional DPOD process, which may reduce complexity and latency. Accordingly, the network entity 105-a may reduce power consumption of the PA while avoiding increased complexity and performance loss at the UE 115-a.

The network entity 105-a may determine one or more statistical attributes associated with one or more PAs (e.g., the RF chain component 210-c) corresponding to the RF chain 205. For example, the network entity 105-a may apply an offline calculation, such as a factory calibration process, to determine, calculate, or otherwise obtain the one or more statistical attributes. The one or more statistical attributes may include at least a mean and a variance (e.g., the first and second statistical moments) of the one or more PA coefficients for each PA of the network entity 105-a. In some examples, the network entity 105-a may be associated with an RRH that may be different from an RRH associated with another network entity 105 (e.g., made by a different system vendor). The RRH may contain the RF chain 205 and the RF chain components 210 (e.g., including one or more PAs). Thus, respective PA transfer functions may differ between the network entity 105-a and another network entity 105.

Additionally, or alternatively, the network entity 105-a may include one or more PAs that may be the same or different from each other. For example, the one or more PAs may be part of the same or different RF chains 205, or the one or more PAs may experience variations in processes, temperatures, quality degradation, or any combination thereof over time, such that the PA transfer functions and PA coefficients may further differ between the one or more PAs or over time at a same PA. Thus, the network entity 105-a may determine one or more statistical attributes (e.g., apply an offline calculation of the mean and the variance) representative of the one or more PA coefficients associated with each PA. The network entity 105-a may provide the one or more statistical attributes (e.g., via a statistical attribute report 225) to a receiving device, such as the UE 115-a, that is to perform the enhanced non-linearity correction procedure.

The UE 115-a may be capable of performing the enhanced non-linearity correction procedure on a signal received from the network entity 105-a, for instance, using the one or more statistical attributes to estimate the PA coefficient(s) of the PA(s) used by the network entity 105-a to transmit the signal. That is, the UE 115-a may perform the enhanced non-linearity correction procedure to approximate or otherwise determine a model (e.g., a PA model) corresponding to a PA transfer function of the PA based on the one or more statistical attributes and the estimated PA coefficients. By approximating the PA model, the UE may determine and correct errors in the received signal. In some examples, the UE 115-a may transmit, to the network entity 105-a, a capability report 215 indicating that the UE is capable of performing the enhanced non-linearity correction procedure.

Additionally, or alternatively, the UE 115-a may transmit, to the network entity 105-a, a statistical attribute report request message 220 requesting that the network entity 105-a transmit a statistical attribute report 225 to the UE 115-a (e.g., based on the UE 115-a transmitting the capability report 215). The statistical attribute report 225 may include an indication of the one or more statistical attributes associated with the one or more PAs (e.g., RF chain component 210-a, 210-b, 210-c, or any combination thereof) of the RF chain 205. In some cases, the UE 115-a may transmit the capability report 215, the statistical attribute report request message 220, or both, to the network entity 105-a via an uplink control channel (e.g., as part of control signaling or a control message via a physical uplink control channel (PUCCH)), an uplink shared channel (e.g., a physical uplink shared channel (PUSCH)), or the like, among other examples.

The network entity 105-a may transmit, to the UE 115-a, a downlink message including the statistical attribute report 225 based on receiving the statistical attribute report request message 220. In some examples, the network entity 105-a may transmit the statistical attribute report 225 upon establishing a connection with the UE 115-a (e.g., may transmit the statistical attribute report 225 once per connection). The network entity 105-a may transmit the statistical attribute report 225 as control signaling (e.g., a medium access control-control element (MAC-CE), an RRC message, or the like) via a physical downlink control channel (PDCCH), or as a downlink data message via a PDSCH, or some combination thereof. In some examples, a size of the statistical attribute report 225 (e.g., a quantity of statistical attributes indicated in the statistical attribute report 225) may be based on a quantity of PAs of the network entity 105-a (e.g., on a quantity of RF chains 205). Thus, the size of the statistical attribute report 225 may be different for different network entities 105. For example, the size of the statistical attribute report 225 may be a quantity of antennas of the RF chain 205 multiplied by 2 (e.g., including respective mean and variance values for each antenna). In some examples, the network entity 105-a may transmit from a subset of transmitting antennas, and may include respective statistical attributes associated with each antenna of the subset of transmitting antennas in the statistical attribute report 225. Here, the network entity 105-a may refrain from including statistical attributes associated with other (e.g., unused) transmitting antennas.

The network entity 105-a may also transmit, to the UE 115-a, a data signal 230 using the RF chain 205 and via a downlink channel, such as a PDSCH. For example, the data signal 230 may be amplified by a PA of the RF chain 205, such as RF chain component 210-c.

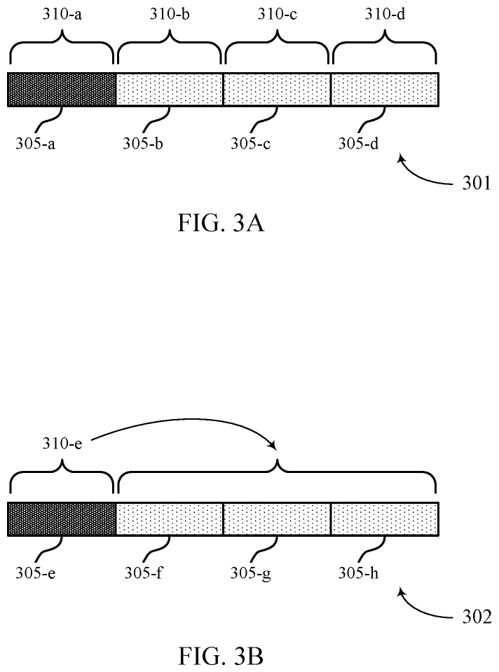

The UE 115-a may perform the enhanced non-linearity correction procedure on the data signal 230 using one or more of the statistical attributes indicated in the statistical attribute report 225. In some examples, the enhanced non-linearity correction procedure may be a DPOD procedure. In some examples, the enhanced non-linearity correction procedure may be based on an LMMSE estimation (e.g., rather than a LS estimation). In some examples, performing the enhanced non-linearity correction procedure may include performing PA coefficient estimation periodically (e.g., with a period greater than one slot, or once per N slots, rather than at each time slot), as described with more detail with respect to FIGS. 3A and 3B.

FIGS. 3A and 3B show examples of resource diagrams 301 and 302, respectively, that support enhanced non-linearity correction based on statistical moments in accordance with one or more aspects of the present disclosure. The resource diagrams 301 and 302 may implement or be implemented by one or more aspects of the wireless communications system 100 and the wireless communications system 200 described with reference to FIGS. 1 and 2, respectively. For example, the resource diagrams 301 and 302 may be implemented by a network entity 105 and a UE 115 as described with reference to FIGS. 1 and 2 to support an enhanced non-linearity correction procedure.

For example, the resource diagram 301 may be utilized during an example non-linearity correction (e.g., a non-enhanced or typical non-linearity correction) procedure performed at a receiving device (e.g., a UE) for (e.g., on) a signal received from a transmitting device (e.g., a network entity). In the non-linearity correction procedure illustrated in the resource diagram 301, the UE may perform a PA coefficients estimation 310 for each slot 305 of the signal (e.g., PA coefficients estimations 310-a, 310-b, 310-c, and 310-d are performed by the UE for slots 305-a, 305-b, 305-c, and 305-d, respectively). In a PA coefficients estimation 310, the UE may estimate PA coefficient(s) of a PA(s) used by the network entity to transmit the signal within the corresponding slot 305. Even in scenarios in which the PA coefficients do not change much from one slot 305 to the next (e.g., from slot 305-a to slot 305-b), the UE may perform a typical non-linearity correction procedure by performing a PA coefficients estimation 310 at each slot 305 to account for errors in the slot 305 and prevent performance loss. However, performing such a procedure at every slot 305 may consume significant processing power at the UE and may introduce significant latency, as the UE must perform the procedure for each slot 305 before decoding or otherwise obtaining the signal.

In another example, the resource diagram 302 may be utilized during an example non-linearity correction procedure (e.g., an enhanced non-linearity correction procedure) performed at the UE based on one or more statistical attributes. The UE may receive, from the network entity, an indication of the one or more statistical attributes associated with a PA of the network entity and may utilize the one or more statistical attributes to estimate the PA coefficients for the signal. In this example, the PA coefficients estimation rate (e.g., the rate at which the UE performs the PA coefficients estimation(s) 310 for the signal) is reduced. For example, in FIG. 3B, the UE may perform a PA coefficients estimation 310-e according to a periodicity (e.g., once in a period of four slots, instead of once in every slot). The UE may perform the PA coefficients estimation 310-e for slot 305-e and the UE (e.g., a UE 115) may use the PA coefficients estimation 310-e for subsequent slots 305-f, 305-g, and 305-h (e.g., the remaining slots in the period).

In some examples, an estimation accuracy of slots 305-f, 305-g, and 305-h may depend on the estimation accuracy of slot 305-e, where an estimation accuracy of a slot 305 may correspond to an ability of the UE to correct any errors in and successfully decode the signal associated with the slot 305. For example, if slot 305-e is associated with a low SNR and the slots 305-f, 305-g, and 305-h are associated with a high SNR, the PA coefficients estimation 310-e may have a relatively low accuracy (e.g., due to using an LS method), and each of the slots 305-e, 305-f, 305-g, and 305-h may be affected by the low accuracy (e.g., the UE may not be able to accurately correct errors in the slots 305-e through 305-h). According to the techniques described herein, however, the UE may implement the enhanced non-linearity correction method using the statistical attributes associated with the PA coefficients to perform an LMMSE estimation (e.g., rather than an LS estimation) of the PA coefficients. While an LS estimation may yield severely degraded performance (e.g., in scenarios with low SNR), the enhanced non-linearity correction method (e.g., using an LMMSE estimation) described herein may experience relatively less negative impact on estimation performance (e.g., relatively more accurate PDSCH cleaning (e.g., noise removal or error correction from non-linearity) in the event that the slot 305-e experiences low SNR.

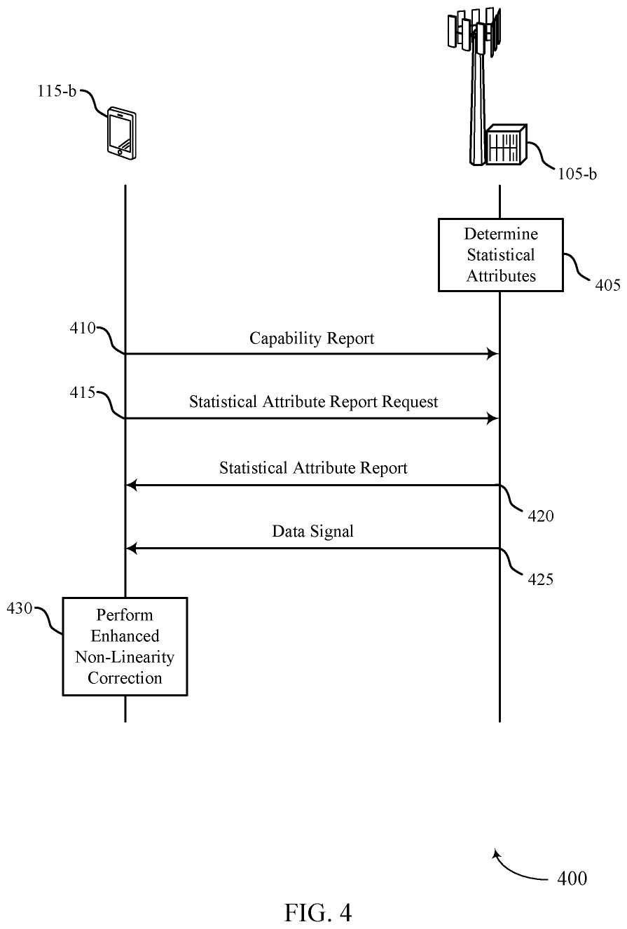

FIG. 4 shows an example of a process flow 400 that supports enhanced non-linearity correction based on statistical moments in accordance with one or more aspects of the present disclosure. In some examples, the process flow 400 may be implemented by, or may implement aspects of, wireless communications systems 100 and 200 and resource diagrams 301 and 302. For example, the process flow 400 includes a network entity 105-b (e.g., a first wireless device) and a UE 115-b (e.g., a second wireless device), which may be examples of the corresponding devices described with reference to FIGS. 1 and 2. Following the process flow 400, the UE 115-b may perform an enhanced non-linearity correction procedure on a data signal. Alternative examples of the following may be implemented, where some steps are performed in a different order than described or are not performed at all. In some cases, steps may include additional features not mentioned below, or further steps may be added. Although the UE 115-b and the network entity 105-b are shown performing the operations of the process flow 400, some aspects of some operations may also be performed by one or more other wireless devices.

The network entity 105-b may establish a connection with the UE 115-b. One or more of the steps of the process flow 400 may be based on the connection established between the UE 115-b and the network entity 105-b.

At 405, the network entity 105-b may determine one or more statistical attributes associated with one or more PA coefficients for a PA of the network entity 105-b. The one or more statistical attributes may include a mean (e.g., first statistical moment, or average value) associated with the one or more PA coefficients and a variance (e.g., second statistical moment, or the spread of values) associated with the one or more PA coefficients. In some examples, the PA may correspond to a portion of a set of multiple antennas at the network entity 105-b. In some examples, the network entity 105-b may determine one or more first statistical attributes associated with one or more first PA coefficients for a first PA in a first transmit chain, and one or more second statistical attributes associated with one or more second PA coefficients for a second PA in a second transmit chain.

At 410, the UE 115-b may transmit, to the network entity 105-b, a capability report indicating that the UE 115-b may be capable of performing an enhanced non-linearity correction procedure.

At 415, the UE 115-b may transmit, to the network entity 105-b, a request for a statistical attribute report associated with the PA of the network entity 105-b.

At 420, the network entity 105-b may transmit, to the UE 115-b, the statistical attribute report in response to the request for the statistical attribute report received at 415. For example, the network entity 105-b may transmit the statistical attribute report based on establishing a connection with the UE 115-b, determining the one or more statistical attributes at 405, receiving the capability report from the UE 115-b at 410, receiving the statistical attribute report request, or any combination thereof. In some examples, the statistical attribute report may be transmitted and received via a MAC-CE, an RRC message, a PDCCH, a PDSCH, or any combination thereof.

The statistical attribute report may include one or more statistical attributes (e.g., the one or more statistical attributes determined by the network entity 105-b at 405) associated with one or more PA coefficients for the PA. For example, the statistical attribute report may include a mean and a variance associated with the one or more PA coefficients. In some examples, the statistical attribute report may include one or more first statistical attributes associated with one or more first PA coefficients for a first PA in a first transmit chain, and one or more second statistical attributes associated with one or more second PA coefficients for a second PA in a second transmit chain.

In some examples, the network entity 105-b may transmit the statistical attribute report in accordance with a quantity of antennas at the network entity 105-b. That is, the quantity of statistical attributes included in the report (e.g., a size of the statistical attribute report) may be based on the quantity of antennas. For example, the network entity 105-b may include the mean and the variance associated with each of 10 antennas in the statistical attribute report, for a total of 20 entries in the statistical attribute report.

At 425, the network entity 105-b may transmit, to the UE 115-b, a data signal based on the one or more PA coefficients for the PA. For example, the data signal may be amplified by the PA as it passes through the RF chain (e.g., the RF chain 205, as described with reference to FIG. 2), and the one or more PA coefficients associated with that PA may have been included in the statistical attribute report at 420.

At 430, the UE 115-b may perform an enhanced non-linearity correction procedure on the data signal based on the statistical attribute report. For example, the non-linearity correction procedure may be a DPOD correction procedure, and may be based on LMMSE (e.g., rather than based on LS). In some examples, the UE 115-b may perform the enhanced non-linearity correction procedure according to a periodicity associated with a period (e.g., four slots). In some examples, the UE 115-b may perform the enhanced non-linearity correction procedure for a first slot in the period (e.g., refraining from performing the procedure on the remaining slots in the period). In such examples, the UE 115-b may apply a result of the enhanced non-linearity procedure for the first slot in the period to one or more remaining slots in the period (e.g., as described in more detail with reference to FIGS. 3A and 3B).

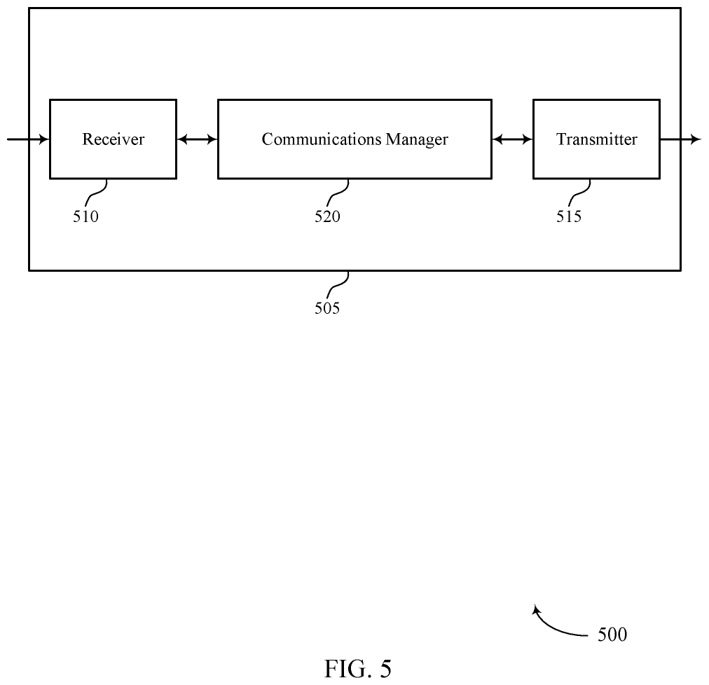

FIG. 5 shows a block diagram 500 of a device 505 that supports enhanced non-linearity correction based on statistical moments in accordance with one or more aspects of the present disclosure. The device 505 may be an example of aspects of a second wireless device as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to enhanced non-linearity correction based on statistical moments). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to enhanced non-linearity correction based on statistical moments). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of enhanced non-linearity correction based on statistical moments as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor. If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for transmitting, to a first wireless device, a request for a statistical attribute report associated with a PA of the first wireless device. The communications manager 520 is capable of, configured to, or operable to support a means for receiving, in response to the request, the statistical attribute report from the first wireless device, where the statistical attribute report includes one or more statistical attributes associated with one or more PA coefficients for the PA. The communications manager 520 is capable of, configured to, or operable to support a means for receiving, from the first wireless device, a data signal based on the one or more PA coefficients for the PA. The communications manager 520 is capable of, configured to, or operable to support a means for performing, based on the statistical attribute report and the data signal, an enhanced non-linearity correction procedure on the data signal.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced processing, reduced power consumption, and more efficient utilization of communication resources.

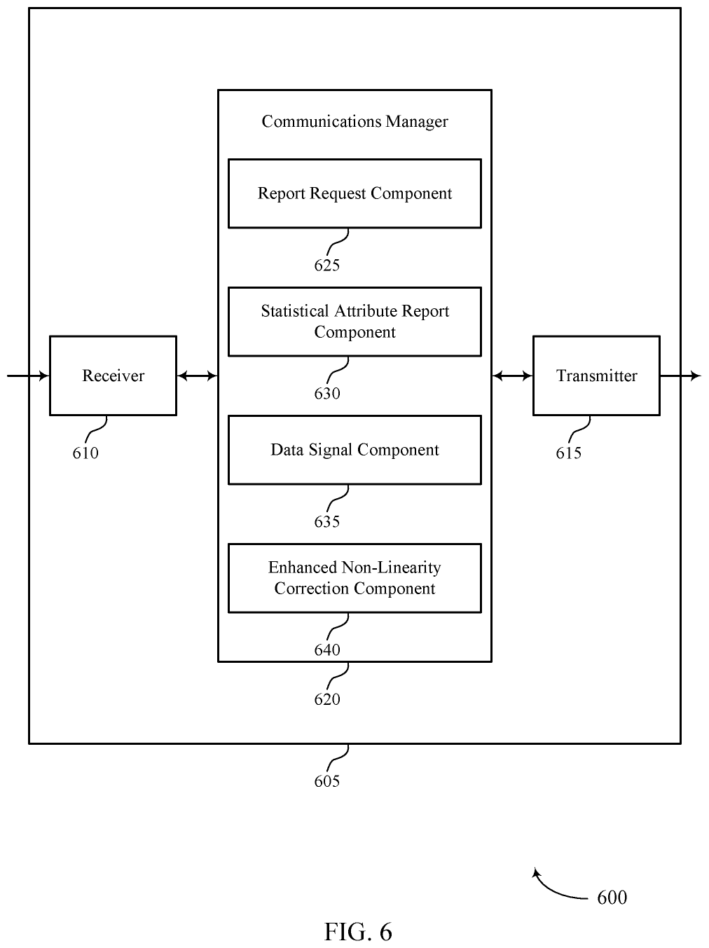

FIG. 6 shows a block diagram 600 of a device 605 that supports enhanced non-linearity correction based on statistical moments in accordance with one or more aspects of the present disclosure. The device 605 may be an example of aspects of a device 505 or a second wireless device as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to enhanced non-linearity correction based on statistical moments). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to enhanced non-linearity correction based on statistical moments). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of enhanced non-linearity correction based on statistical moments as described herein. For example, the communications manager 620 may include a report request component 625, a statistical attribute report component 630, a data signal component 635, an enhanced non-linearity correction component 640, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The report request component 625 is capable of, configured to, or operable to support a means for transmitting, to a first wireless device, a request for a statistical attribute report associated with a PA of the first wireless device. The statistical attribute report component 630 is capable of, configured to, or operable to support a means for receiving, in response to the request, the statistical attribute report from the first wireless device, where the statistical attribute report includes one or more statistical attributes associated with one or more PA coefficients for the PA. The data signal component 635 is capable of, configured to, or operable to support a means for receiving, from the first wireless device, a data signal based on the one or more PA coefficients for the PA. The enhanced non-linearity correction component 640 is capable of, configured to, or operable to support a means for performing, based on the statistical attribute report and the data signal, an enhanced non-linearity correction procedure on the data signal.

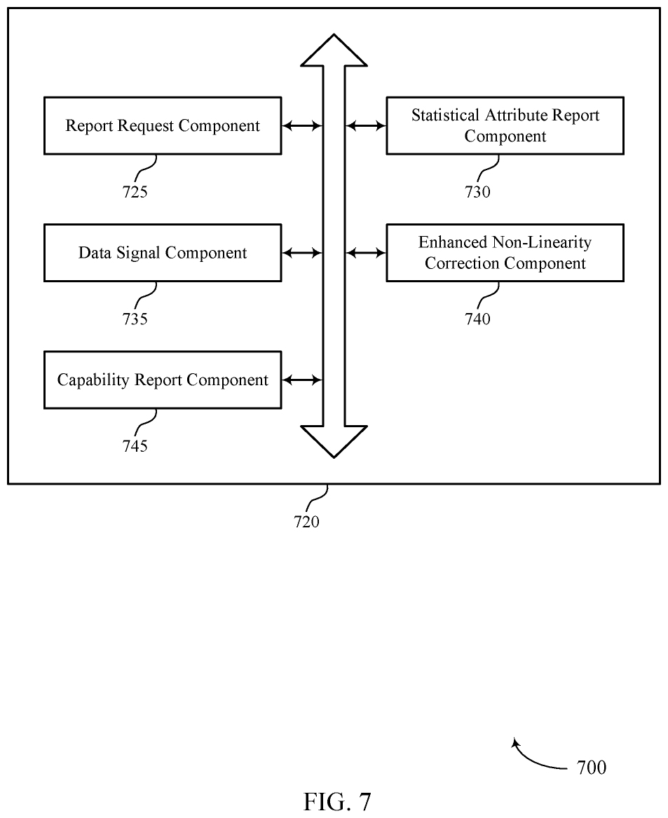

FIG. 7 shows a block diagram 700 of a communications manager 720 that supports enhanced non-linearity correction based on statistical moments in accordance with one or more aspects of the present disclosure. The communications manager 720 may be an example of aspects of a communications manager 520, a communications manager 620, or both, as described herein. The communications manager 720, or various components thereof, may be an example of means for performing various aspects of enhanced non-linearity correction based on statistical moments as described herein. For example, the communications manager 720 may include a report request component 725, a statistical attribute report component 730, a data signal component 735, an enhanced non-linearity correction component 740, a capability report component 745, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The report request component 725 is capable of, configured to, or operable to support a means for transmitting, to a first wireless device, a request for a statistical attribute report associated with a PA of the first wireless device. The statistical attribute report component 730 is capable of, configured to, or operable to support a means for receiving, in response to the request, the statistical attribute report from the first wireless device, where the statistical attribute report includes one or more statistical attributes associated with one or more PA coefficients for the PA. The data signal component 735 is capable of, configured to, or operable to support a means for receiving, from the first wireless device, a data signal based on the one or more PA coefficients for the PA. The enhanced non-linearity correction component 740 is capable of, configured to, or operable to support a means for performing, based on the statistical attribute report and the data signal, an enhanced non-linearity correction procedure on the data signal.

In some examples, the capability report component 745 is capable of, configured to, or operable to support a means for transmitting, to the first wireless device, a capability report indicating that the second wireless device is capable of performing an enhanced non-linearity correction, the statistical attribute report is received based on the capability report.

In some examples, to support performing the enhanced non-linearity correction procedure, the enhanced non-linearity correction component 740 is capable of, configured to, or operable to support a means for performing the enhanced non-linearity correction procedure according to a periodicity associated with a period.

In some examples, to support performing the enhanced non-linearity correction procedure, the enhanced non-linearity correction component 740 is capable of, configured to, or operable to support a means for performing the enhanced non-linearity correction procedure for a first slot in the period.

In some examples, to support performing the enhanced non-linearity correction procedure for the first slot in the period, the enhanced non-linearity correction component 740 is capable of, configured to, or operable to support a means for applying a result of the enhanced non-linearity correction procedure for the first slot in the period to a set of remaining slots in the period.

In some examples, the enhanced non-linearity correction procedure is based on LMMSE. In some examples, the enhanced non-linearity correction procedure is a DPOD correction.

In some examples, to support receiving the statistical attribute report, the statistical attribute report component 730 is capable of, configured to, or operable to support a means for receiving the statistical attribute report in accordance with a quantity of antennas at the first wireless device, where the one or more statistical attributes include a quantity of statistical attributes that is based on the quantity of antennas.

In some examples, the one or more statistical attributes includes a mean associated with the one or more PA coefficients and a variance associated with the one or more PA coefficients.

In some examples, the statistical attribute report component 730 is capable of, configured to, or operable to support a means for establishing a connection with the first wireless device, where receiving the statistical attribute report is based on establishing the connection.

In some examples, to support receiving the statistical attribute report, the statistical attribute report component 730 is capable of, configured to, or operable to support a means for receiving the statistical attribute report via a MAC-CE, an RRC message, a PDCCH, an PDSCH, or a combination thereof.

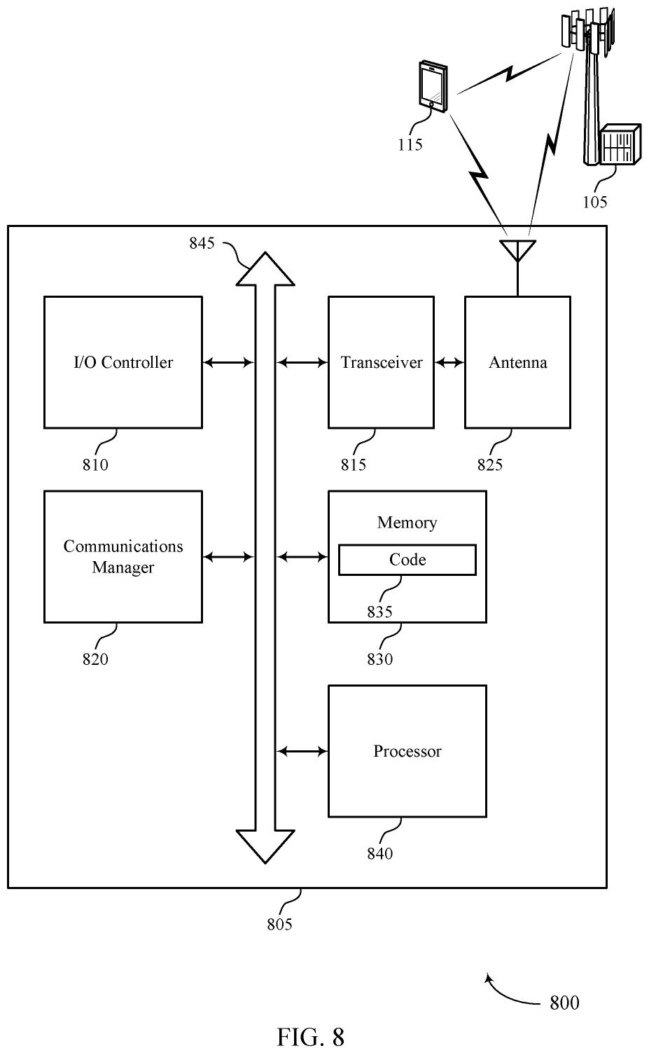

FIG. 8 shows a diagram of a system 800 including a device 805 that supports enhanced non-linearity correction based on statistical moments in accordance with one or more aspects of the present disclosure. The device 805 may be an example of or include the components of a device 505, a device 605, or a second wireless device as described herein. The device 805 may include components for bi-directional voice and data communications including components for transmitting and receiving communications, such as a communications manager 820, an I/O controller 810, a transceiver 815, an antenna 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include RAM and ROM. The at least one memory 830 may store computer-readable, computer-executable code 835 including instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may contain, among other things, a BIOS which may control basic hardware or software operation such as the interaction with peripheral components or devices.

The at least one processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting enhanced non-linearity correction based on statistical moments). For example, the device 805 or a component of the device 805 may include at least one processor 840 and at least one memory 830 coupled with or to the at least one processor 840, the at least one processor 840 and at least one memory 830 configured to perform various functions described herein. In some examples, the at least one processor 840 may include multiple processors and the at least one memory 830 may include multiple memories. One or more of the multiple processors may be coupled with one or more of the multiple memories, which may, individually or collectively, be configured to perform various functions herein.

The communications manager 820 may support wireless communications in accordance with examples as disclosed herein. For example, the communications manager 820 is capable of, configured to, or operable to support a means for transmitting, to a first wireless device, a request for a statistical attribute report associated with a PA of the first wireless device. The communications manager 820 is capable of, configured to, or operable to support a means for receiving, in response to the request, the statistical attribute report from the first wireless device, where the statistical attribute report includes one or more statistical attributes associated with one or more PA coefficients for the PA. The communications manager 820 is capable of, configured to, or operable to support a means for receiving, from the first wireless device, a data signal based on the one or more PA coefficients for the PA. The communications manager 820 is capable of, configured to, or operable to support a means for performing, based on the statistical attribute report and the data signal, an enhanced non-linearity correction procedure on the data signal.

By including or configuring the communications manager 820 in accordance with examples as described herein, the device 805 may support techniques for reduced latency, improved user experience related to reduced processing, reduced power consumption, more efficient utilization of communication resources, and longer battery life.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of enhanced non-linearity correction based on statistical moments as described herein, or the at least one processor 840 and the at least one memory 830 may be otherwise configured to, individually or collectively, perform or support such operations.

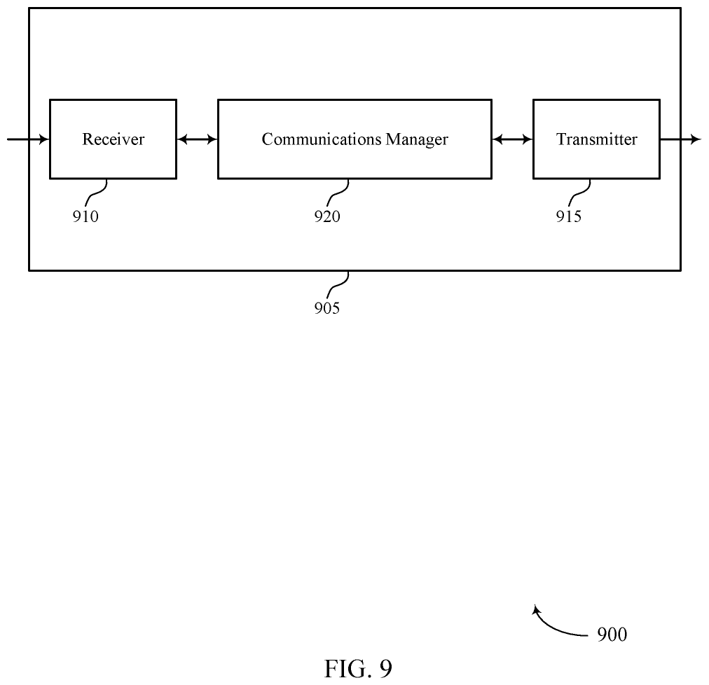

FIG. 9 shows a block diagram 900 of a device 905 that supports enhanced non-linearity correction based on statistical moments in accordance with one or more aspects of the present disclosure. The device 905 may be an example of aspects of a first wireless device as described herein. The device 905 may include a receiver 910, a transmitter 915, and a communications manager 920. The device 905, or one or more components of the device 905 (e.g., the receiver 910, the transmitter 915, and the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of enhanced non-linearity correction based on statistical moments as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor. If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for receiving, from a second wireless device, a request for a statistical attribute report associated with a PA of the first wireless device. The communications manager 920 is capable of, configured to, or operable to support a means for transmitting, in response to the request, the statistical attribute report to the second wireless device, where the statistical attribute report includes one or more statistical attributes associated with one or more PA coefficients for the PA of the first wireless device. The communications manager 920 is capable of, configured to, or operable to support a means for transmitting, to the second wireless device, a data signal based on the one or more PA coefficients for the PA.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced processing, reduced power consumption, and more efficient utilization of communication resources.

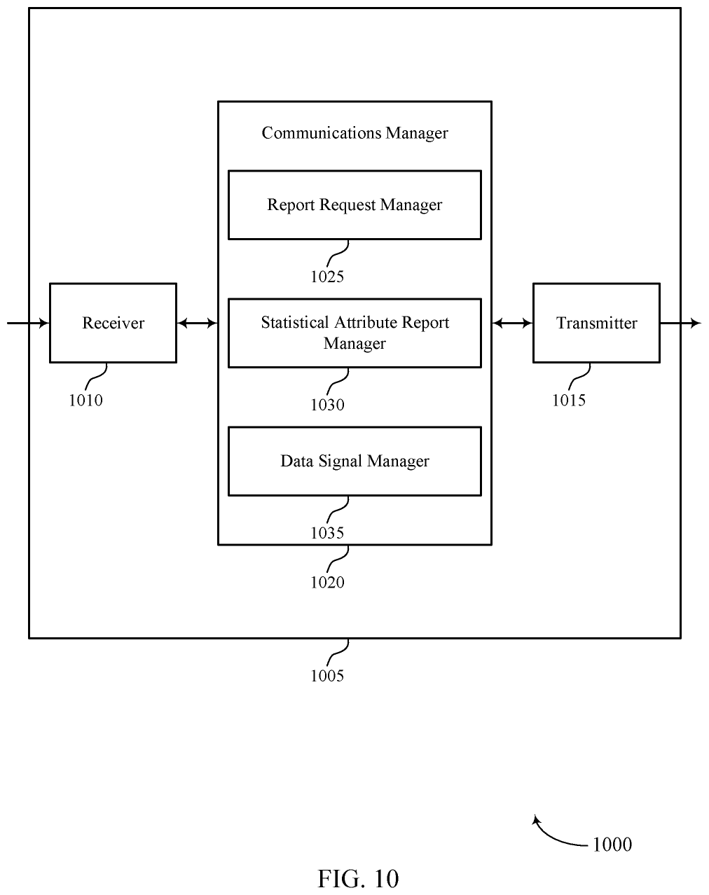

FIG. 10 shows a block diagram 1000 of a device 1005 that supports enhanced non-linearity correction based on statistical moments in accordance with one or more aspects of the present disclosure. The device 1005 may be an example of aspects of a device 905 or a first wireless device as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of enhanced non-linearity correction based on statistical moments as described herein. For example, the communications manager 1020 may include a report request manager 1025, a statistical attribute report manager 1030, a data signal manager 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The report request manager 1025 is capable of, configured to, or operable to support a means for receiving, from a second wireless device, a request for a statistical attribute report associated with a PA of the first wireless device. The statistical attribute report manager 1030 is capable of, configured to, or operable to support a means for transmitting, in response to the request, the statistical attribute report to the second wireless device, where the statistical attribute report includes one or more statistical attributes associated with one or more PA coefficients for the PA of the first wireless device. The data signal manager 1035 is capable of, configured to, or operable to support a means for transmitting, to the second wireless device, a data signal based on the one or more PA coefficients for the PA.

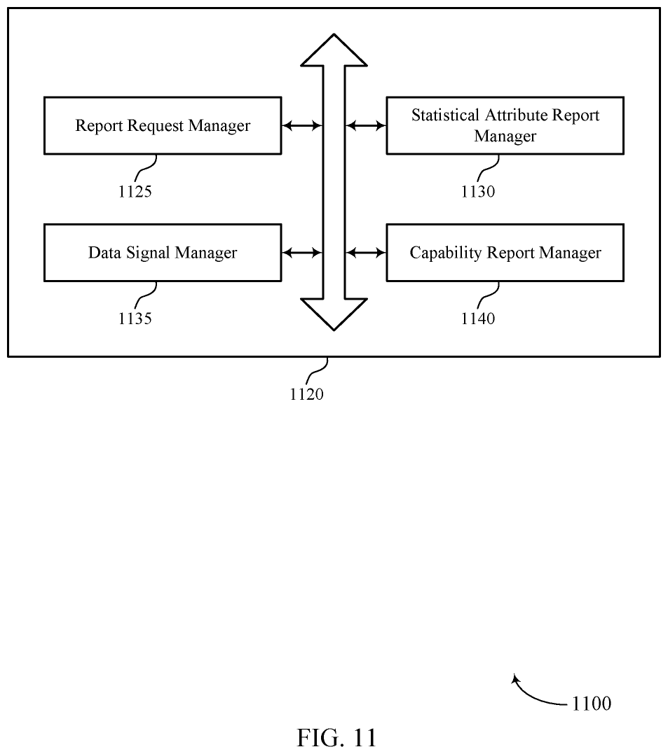

FIG. 11 shows a block diagram 1100 of a communications manager 1120 that supports enhanced non-linearity correction based on statistical moments in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of enhanced non-linearity correction based on statistical moments as described herein. For example, the communications manager 1120 may include a report request manager 1125, a statistical attribute report manager 1130, a data signal manager 1135, a capability report manager 1140, or any combination thereof. Each of these components, or components or subcomponents thereof (e.g., one or more processors, one or more memories), may communicate, directly or indirectly, with one another (e.g., via one or more buses).

The communications manager 1120 may support wireless communications in accordance with examples as disclosed herein. The report request manager 1125 is capable of, configured to, or operable to support a means for receiving, from a second wireless device, a request for a statistical attribute report associated with a PA of the first wireless device. The statistical attribute report manager 1130 is capable of, configured to, or operable to support a means for transmitting, in response to the request, the statistical attribute report to the second wireless device, where the statistical attribute report includes one or more statistical attributes associated with one or more PA coefficients for the PA of the first wireless device. The data signal manager 1135 is capable of, configured to, or operable to support a means for transmitting, to the second wireless device, a data signal based on the one or more PA coefficients for the PA.

In some examples, the capability report manager 1140 is capable of, configured to, or operable to support a means for receiving, from the second wireless device, a capability report indicating that the second wireless device is capable of performing an enhanced non-linearity correction, the statistical attribute report is transmitted based on the capability report.

In some examples, to support transmitting the statistical attribute report, the statistical attribute report manager 1130 is capable of, configured to, or operable to support a means for transmitting the statistical attribute report in accordance with a quantity of antennas at the first wireless device, where the one or more statistical attributes include a quantity of statistical attributes that is based on the quantity of antennas.

In some examples, to support transmitting the statistical attribute report, the statistical attribute report manager 1130 is capable of, configured to, or operable to support a means for transmitting, in the statistical attribute report, one or more second statistical attributes associated with one or more second PA coefficients for a second PA of the first wireless device.

In some examples, the PA corresponds to a first transmit chain and the second PA corresponds to a second transmit chain. In some examples, the PA corresponds to a portion of a set of multiple antennas of the first wireless device.

In some examples, the one or more statistical attributes include a mean associated with the one or more PA coefficients and a variance associated with the one or more PA coefficients.

In some examples, the statistical attribute report manager 1130 is capable of, configured to, or operable to support a means for establishing a connection with the second wireless device, where transmitting the statistical attribute report is based on establishing the connection.

In some examples, the statistical attribute report manager 1130 is capable of, configured to, or operable to support a means for determining the one or more statistical attributes associated with the one or more PA coefficients for the PA of the first wireless device.

In some examples, to support transmitting the statistical attribute report, the statistical attribute report manager 1130 is capable of, configured to, or operable to support a means for transmitting the statistical attribute report via a MAC-CE, an RRC message, a PDCCH, an PDSCH, or a combination thereof.

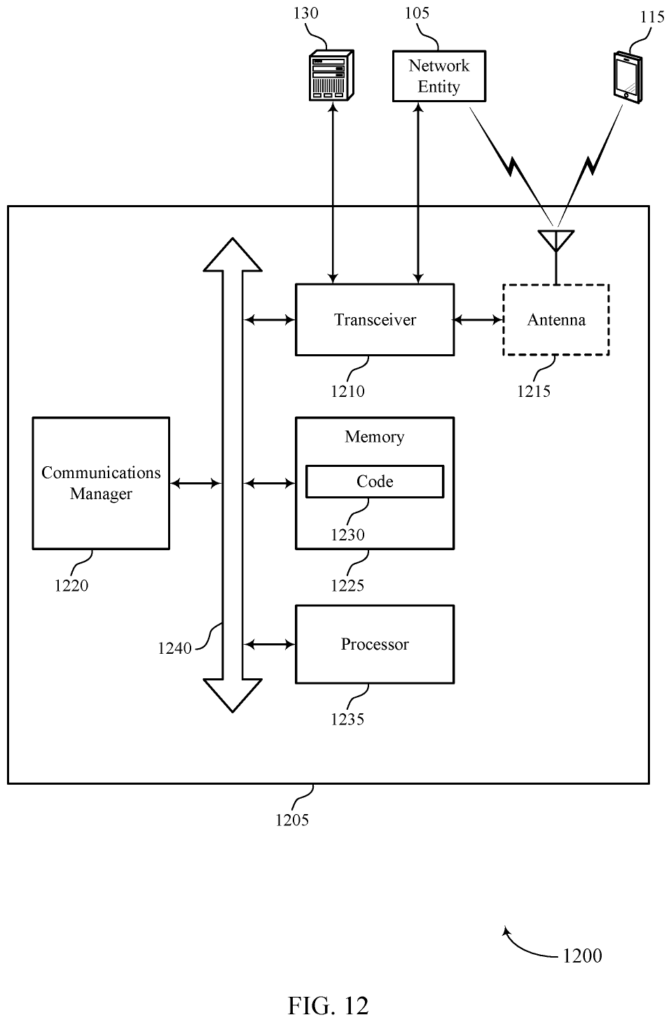

FIG. 12 shows a diagram of a system 1200 including a device 1205 that supports enhanced non-linearity correction based on statistical moments in accordance with one or more aspects of the present disclosure. The device 1205 may be an example of or include the components of a device 905, a device 1005, or a first wireless device as described herein. The device 1205 may include components for bi-directional voice and data communications including components for transmitting and receiving communications, such as a communications manager 1220, a transceiver 1210, an antenna 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., a communication link 125, a backhaul communication link 120, a midhaul communication link 162, a fronthaul communication link 168).

The at least one memory 1225 may include RAM, ROM, or any combination thereof. The at least one memory 1225 may store computer-readable, computer-executable code 1230 including instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may contain, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting enhanced non-linearity correction based on statistical moments). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225). In some implementations, the at least one processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the at least one processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for receiving, from a second wireless device, a request for a statistical attribute report associated with a PA of the first wireless device. The communications manager 1220 is capable of, configured to, or operable to support a means for transmitting, in response to the request, the statistical attribute report to the second wireless device, where the statistical attribute report includes one or more statistical attributes associated with one or more PA coefficients for the PA of the first wireless device. The communications manager 1220 is capable of, configured to, or operable to support a means for transmitting, to the second wireless device, a data signal based on the one or more PA coefficients for the PA.

By including or configuring the communications manager 1220 in accordance with examples as described herein, the device 1205 may support techniques for reduced latency, improved user experience related to reduced processing, reduced power consumption, more efficient utilization of communication resources, and longer battery life.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of enhanced non-linearity correction based on statistical moments as described herein, or the at least one processor 1235 and the at least one memory 1225 may be otherwise configured to, individually or collectively, perform or support such operations.

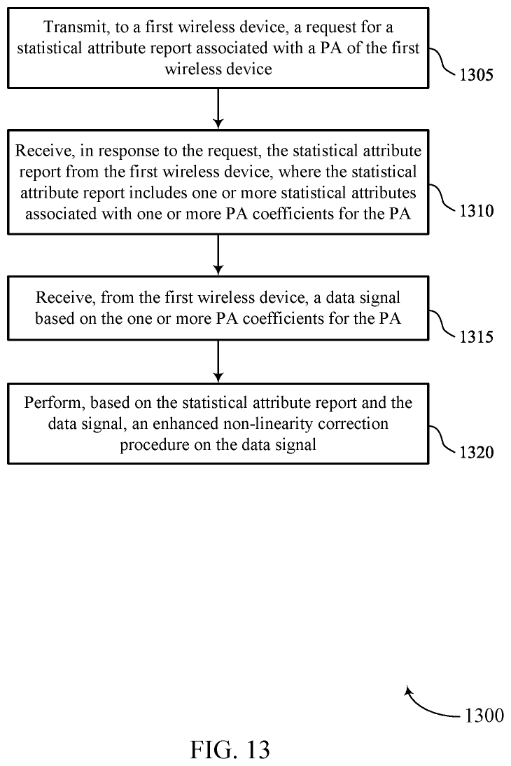

FIG. 13 shows a flowchart illustrating a method 1300 that supports enhanced non-linearity correction based on statistical moments in accordance with aspects of the present disclosure. The operations of the method 1300 may be implemented by a second wireless device or its components as described herein. For example, the operations of the method 1300 may be performed by a second wireless device as described with reference to FIGS. 1 through 8. In some examples, a second wireless device may execute a set of instructions to control the functional elements of the second wireless device to perform the described functions. Additionally, or alternatively, the second wireless device may perform aspects of the described functions using special-purpose hardware.

At 1305, the method may include transmitting, to a first wireless device, a request for a statistical attribute report associated with a PA of the first wireless device. The operations of block 1305 may be performed in accordance with examples as disclosed herein. In some examples, aspects of the operations of 1305 may be performed by a report request component 725 as described with reference to FIG. 7.

At 1310, the method may include receiving, in response to the request, the statistical attribute report from the first wireless device, where the statistical attribute report includes one or more statistical attributes associated with one or more PA coefficients for the PA. The operations of block 1310 may be performed in accordance with examples as disclosed herein. In some examples, aspects of the operations of 1310 may be performed by a statistical attribute report component 730 as described with reference to FIG. 7.

At 1315, the method may include receiving, from the first wireless device, a data signal based on the one or more PA coefficients for the PA. The operations of block 1315 may be performed in accordance with examples as disclosed herein. In some examples, aspects of the operations of 1315 may be performed by a data signal component 735 as described with reference to FIG. 7.

At 1320, the method may include performing, based on the statistical attribute report and the data signal, an enhanced non-linearity correction procedure on the data signal. The operations of block 1320 may be performed in accordance with examples as disclosed herein. In some examples, aspects of the operations of 1320 may be performed by an enhanced non-linearity correction component 740 as described with reference to FIG. 7.

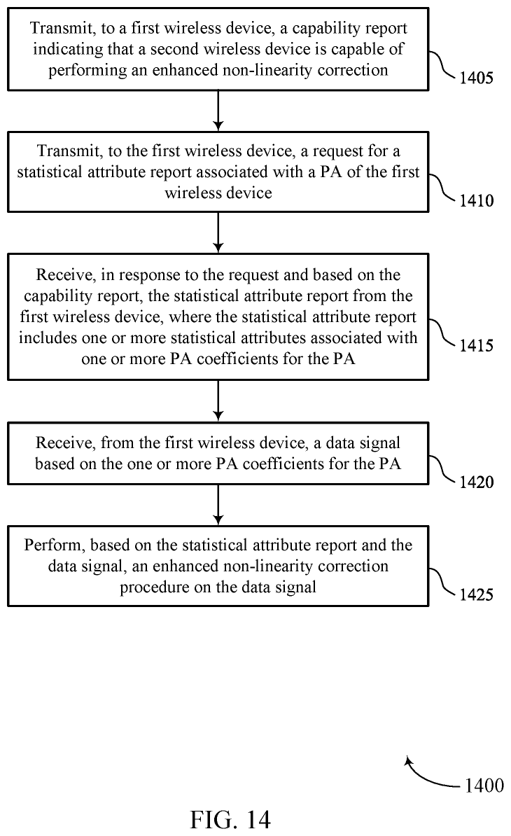

FIG. 14 shows a flowchart illustrating a method 1400 that supports enhanced non-linearity correction based on statistical moments in accordance with aspects of the present disclosure. The operations of the method 1400 may be implemented by a second wireless device or its components as described herein. For example, the operations of the method 1400 may be performed by a second wireless device as described with reference to FIGS. 1 through 8. In some examples, a second wireless device may execute a set of instructions to control the functional elements of the second wireless device to perform the described functions. Additionally, or alternatively, the second wireless device may perform aspects of the described functions using special-purpose hardware.

At 1405, the method may include transmitting, to the first wireless device, a capability report indicating that the second wireless device is capable of performing an enhanced non-linearity correction, the statistical attribute report is received based on the capability report. The operations of block 1405 may be performed in accordance with examples as disclosed herein. In some examples, aspects of the operations of 1405 may be performed by a capability report component 745 as described with reference to FIG. 7.

At 1410, the method may include transmitting, to a first wireless device, a request for a statistical attribute report associated with a PA of the first wireless device. The operations of block 1410 may be performed in accordance with examples as disclosed herein. In some examples, aspects of the operations of 1410 may be performed by a report request component 725 as described with reference to FIG. 7.

At 1415, the method may include receiving, in response to the request, the statistical attribute report from the first wireless device, where the statistical attribute report includes one or more statistical attributes associated with one or more PA coefficients for the PA. The operations of block 1415 may be performed in accordance with examples as disclosed herein. In some examples, aspects of the operations of 1415 may be performed by a statistical attribute report component 730 as described with reference to FIG. 7.

At 1420, the method may include receiving, from the first wireless device, a data signal based on the one or more PA coefficients for the PA. The operations of block 1420 may be performed in accordance with examples as disclosed herein. In some examples, aspects of the operations of 1420 may be performed by a data signal component 735 as described with reference to FIG. 7.

At 1425, the method may include performing, based on the statistical attribute report and the data signal, an enhanced non-linearity correction procedure on the data signal. The operations of block 1425 may be performed in accordance with examples as disclosed herein. In some examples, aspects of the operations of 1425 may be performed by an enhanced non-linearity correction component 740 as described with reference to FIG. 7.

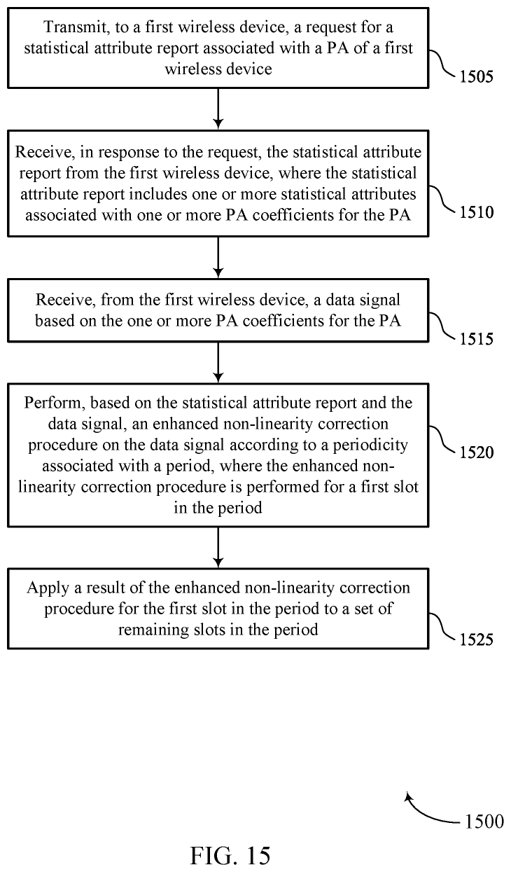

FIG. 15 shows a flowchart illustrating a method 1500 that supports enhanced non-linearity correction based on statistical moments in accordance with aspects of the present disclosure. The operations of the method 1500 may be implemented by a second wireless device or its components as described herein. For example, the operations of the method 1500 may be performed by a second wireless device as described with reference to FIGS. 1 through 8. In some examples, a second wireless device may execute a set of instructions to control the functional elements of the second wireless device to perform the described functions. Additionally, or alternatively, the second wireless device may perform aspects of the described functions using special-purpose hardware.

At 1505, the method may include transmitting, to a first wireless device, a request for a statistical attribute report associated with a PA of the first wireless device. The operations of block 1505 may be performed in accordance with examples as disclosed herein. In some examples, aspects of the operations of 1505 may be performed by a report request component 725 as described with reference to FIG. 7.

At 1510, the method may include receiving, in response to the request, the statistical attribute report from the first wireless device, where the statistical attribute report includes one or more statistical attributes associated with one or more PA coefficients for the PA. The operations of block 1510 may be performed in accordance with examples as disclosed herein. In some examples, aspects of the operations of 1510 may be performed by a statistical attribute report component 730 as described with reference to FIG. 7.

At 1515, the method may include receiving, from the first wireless device, a data signal based on the one or more PA coefficients for the PA. The operations of block 1515 may be performed in accordance with examples as disclosed herein. In some examples, aspects of the operations of 1515 may be performed by a data signal component 735 as described with reference to FIG. 7.

At 1520, the method may include performing, based on the statistical attribute report and the data signal, an enhanced non-linearity correction procedure on the data signal according to a periodicity associated with a period, where the enhanced non-linearity correction procedure is performed for a first slot in the period. The operations of block 1520 may be performed in accordance with examples as disclosed herein. In some examples, aspects of the operations of 1520 may be performed by an enhanced non-linearity correction component 740 as described with reference to FIG. 7.

At 1525, the method may include applying a result of the enhanced non-linearity correction procedure for the first slot in the period to a set of remaining slots in the period. The operations of block 1525 may be performed in accordance with examples as disclosed herein. In some examples, aspects of the operations of 1525 may be performed by an enhanced non-linearity correction component 740 as described with reference to FIG. 7.

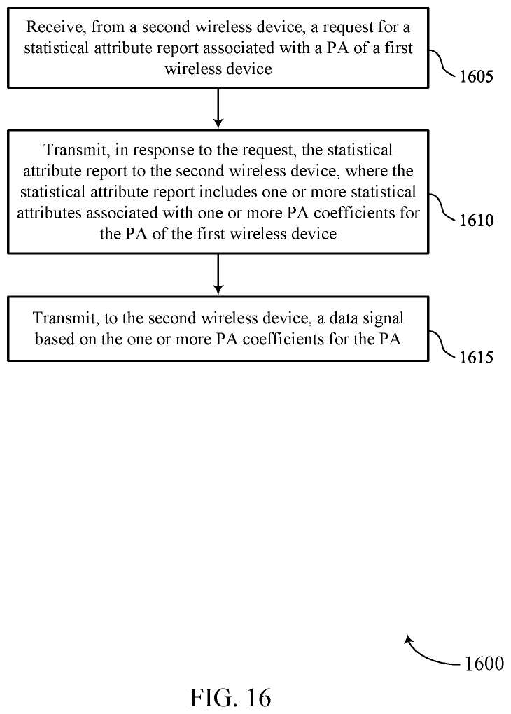

FIG. 16 shows a flowchart illustrating a method 1600 that supports enhanced non-linearity correction based on statistical moments in accordance with aspects of the present disclosure. The operations of the method 1600 may be implemented by a first wireless device or its components as described herein. For example, the operations of the method 1600 may be performed by a first wireless device as described with reference to FIGS. 1 through 4 and 9 through 12. In some examples, a first wireless device may execute a set of instructions to control the functional elements of the first wireless device to perform the described functions. Additionally, or alternatively, the first wireless device may perform aspects of the described functions using special-purpose hardware.

At 1605, the method may include receiving, from a second wireless device, a request for a statistical attribute report associated with a PA of the first wireless device. The operations of block 1605 may be performed in accordance with examples as disclosed herein. In some examples, aspects of the operations of 1605 may be performed by a report request manager 1125 as described with reference to FIG. 11.

At 1610, the method may include transmitting, in response to the request, the statistical attribute report to the second wireless device, where the statistical attribute report includes one or more statistical attributes associated with one or more PA coefficients for the PA of the first wireless device. The operations of block 1610 may be performed in accordance with examples as disclosed herein. In some examples, aspects of the operations of 1610 may be performed by a statistical attribute report manager 1130 as described with reference to FIG. 11.

At 1615, the method may include transmitting, to the second wireless device, a data signal based on the one or more PA coefficients for the PA. The operations of block 1615 may be performed in accordance with examples as disclosed herein. In some examples, aspects of the operations of 1615 may be performed by a data signal manager 1135 as described with reference to FIG. 11.

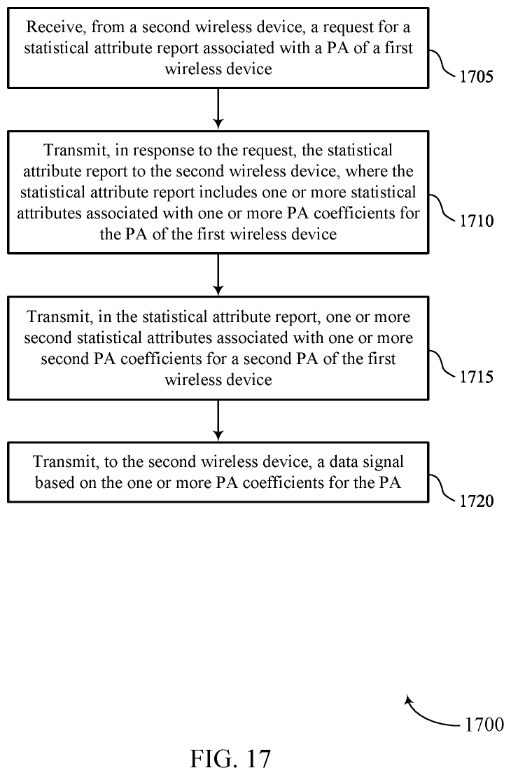

FIG. 17 shows a flowchart illustrating a method 1700 that supports enhanced non-linearity correction based on statistical moments in accordance with aspects of the present disclosure. The operations of the method 1700 may be implemented by a first wireless device or its components as described herein. For example, the operations of the method 1700 may be performed by a first wireless device as described with reference to FIGS. 1 through 4 and 9 through 12. In some examples, a first wireless device may execute a set of instructions to control the functional elements of the first wireless device to perform the described functions. Additionally, or alternatively, the first wireless device may perform aspects of the described functions using special-purpose hardware.

At 1705, the method may include receiving, from a second wireless device, a request for a statistical attribute report associated with a PA of the first wireless device. The operations of block 1705 may be performed in accordance with examples as disclosed herein. In some examples, aspects of the operations of 1705 may be performed by a report request manager 1125 as described with reference to FIG. 11.

At 1710, the method may include transmitting, in response to the request, the statistical attribute report to the second wireless device, where the statistical attribute report includes one or more statistical attributes associated with one or more PA coefficients for the PA of the first wireless device. The operations of block 1710 may be performed in accordance with examples as disclosed herein. In some examples, aspects of the operations of 1710 may be performed by a statistical attribute report manager 1130 as described with reference to FIG. 11.

At 1715, the method may include transmitting, in the statistical attribute report, one or more second statistical attributes associated with one or more second PA coefficients for a second PA of the first wireless device. The operations of block 1715 may be performed in accordance with examples as disclosed herein. In some examples, aspects of the operations of 1715 may be performed by a statistical attribute report manager 1130 as described with reference to FIG. 11.

At 1720, the method may include transmitting, to the second wireless device, a data signal based on the one or more PA coefficients for the PA. The operations of block 1720 may be performed in accordance with examples as disclosed herein. In some examples, aspects of the operations of 1720 may be performed by a data signal manager 1135 as described with reference to FIG. 11.

The following provides an overview of aspects of the present disclosure:
Aspect 1: A method for wireless communications at a first wireless device, comprising: receiving, from a second wireless device, a request for a statistical attribute report associated with a power amplifier of the first wireless device; transmitting, in response to the request, the statistical attribute report to the second wireless device, wherein the statistical attribute report comprises one or more statistical attributes associated with one or more power amplifier coefficients for the power amplifier of the first wireless device; and transmitting, to the second wireless device, a data signal based at least in part on the one or more power amplifier coefficients for the power amplifier.
Aspect 2: The method of aspect 1, further comprising: receiving, from the second wireless device, a capability report indicating that the second wireless device is capable of performing an enhanced non-linearity correction, the statistical attribute report is transmitted based at least in part on the capability report.
Aspect 3: The method of any of aspects 1 through 2, wherein transmitting the statistical attribute report comprises: transmitting the statistical attribute report in accordance with a quantity of antennas at the first wireless device, wherein the one or more statistical attributes comprise a quantity of statistical attributes that is based at least in part on the quantity of antennas.
Aspect 4: The method of any of aspects 1 through 3, wherein transmitting the statistical attribute report comprises: transmitting, in the statistical attribute report, one or more second statistical attributes associated with one or more second power amplifier coefficients for a second power amplifier of the first wireless device.
Aspect 5: The method of aspect 4, wherein the power amplifier corresponds to a first transmit chain and the second power amplifier corresponds to a second transmit chain.
Aspect 6: The method of any of aspects 1 through 5, wherein the power amplifier corresponds to a portion of a plurality of antennas of the first wireless device.
Aspect 7: The method of any of aspects 1 through 6, wherein the one or more statistical attributes comprise a mean associated with the one or more power amplifier coefficients and a variance associated with the one or more power amplifier coefficients.
Aspect 8: The method of any of aspects 1 through 7, further comprising: establishing a connection with the second wireless device, wherein transmitting the statistical attribute report is based at least in part on establishing the connection.
Aspect 9: The method of any of aspects 1 through 8, further comprising: determining the one or more statistical attributes associated with the one or more power amplifier coefficients for the power amplifier of the first wireless device.
Aspect 10: The method of any of aspects 1 through 9, wherein transmitting the statistical attribute report comprises: transmitting the statistical attribute report via a MAC-CE, an RRC message, a PDCCH, an PDSCH, or a combination thereof.
Aspect 11: A method for wireless communications at a second wireless device, comprising: transmitting, to a first wireless device, a request for a statistical attribute report associated with a power amplifier of the first wireless device; receiving, in response to the request, the statistical attribute report from the first wireless device, wherein the statistical attribute report comprises one or more statistical attributes associated with one or more power amplifier coefficients for the power amplifier; receiving, from the first wireless device, a data signal based at least in part on the one or more power amplifier coefficients for the power amplifier; and performing, based at least in part on the statistical attribute report and the data signal, an enhanced non-linearity correction procedure on the data signal.
Aspect 12: The method of aspect 11, further comprising: transmitting, to the first wireless device, a capability report indicating that the second wireless device is capable of performing an enhanced non-linearity correction, the statistical attribute report is received based at least in part on the capability report.
Aspect 13: The method of any of aspects 11 through 12, wherein performing the enhanced non-linearity correction procedure comprises: performing the enhanced non-linearity correction procedure according to a periodicity associated with a period.
Aspect 14: The method of aspect 13, wherein performing the enhanced non-linearity correction procedure comprises: performing the enhanced non-linearity correction procedure for a first slot in the period.
Aspect 15: The method of aspect 14, wherein performing the enhanced non-linearity correction procedure for the first slot in the period comprises: applying a result of the enhanced non-linearity correction procedure for the first slot in the period to a set of remaining slots in the period.
Aspect 16: The method of any of aspects 11 through 15, wherein the enhanced non-linearity correction procedure is based at least in part on linear minimum mean square error (LMMSE).
Aspect 17: The method of any of aspects 11 through 16, wherein the enhanced non-linearity correction procedure is a digital post-distortion correction.
Aspect 18: The method of any of aspects 11 through 17, wherein receiving the statistical attribute report comprises: receiving the statistical attribute report in accordance with a quantity of antennas at the first wireless device, wherein the one or more statistical attributes comprise a quantity of statistical attributes that is based at least in part on the quantity of antennas.
Aspect 19: The method of any of aspects 11 through 18, wherein the one or more statistical attributes comprises a mean associated with the one or more power amplifier coefficients and a variance associated with the one or more power amplifier coefficients.
Aspect 20: The method of any of aspects 11 through 19, further comprising: establishing a connection with the first wireless device, wherein receiving the statistical attribute report is based at least in part on establishing the connection.
Aspect 21: The method of any of aspects 11 through 20, wherein receiving the statistical attribute report comprises: receiving the statistical attribute report via a MAC-CE, an RRC message, a PDCCH, an PDSCH, or a combination thereof.
Aspect 22: A first wireless device for wireless communications, comprising one or more memories storing processor-executable code, and one or more processors coupled with the one or more memories and individually or collectively operable to execute the code to cause the first wireless device to perform a method of any of aspects 1 through 10.
Aspect 23: A first wireless device for wireless communications, comprising at least one means for performing a method of any of aspects 1 through 10.
Aspect 24: A non-transitory computer-readable medium storing code for wireless communications, the code comprising instructions executable by a processor to perform a method of any of aspects 1 through 10.
Aspect 25: A second wireless device for wireless communications, comprising one or more memories storing processor-executable code, and one or more processors coupled with the one or more memories and individually or collectively operable to execute the code to cause the second wireless device to perform a method of any of aspects 11 through 21.
Aspect 26: A second wireless device for wireless communications, comprising at least one means for performing a method of any of aspects 11 through 21.
Aspect 27: A non-transitory computer-readable medium storing code for wireless communications, the code comprising instructions executable by a processor to perform a method of any of aspects 11 through 21.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first wireless device, comprising:
one or more memories storing processor-executable code; and
one or more processors coupled with the one or more memories and individually or collectively operable to execute the code to cause the first wireless device to:
receive, from a second wireless device, a request for a statistical attribute report associated with a power amplifier of the first wireless device;
transmit, in response to the request, the statistical attribute report to the second wireless device, wherein the statistical attribute report comprises one or more statistical attributes associated with one or more power amplifier coefficients for the power amplifier of the first wireless device; and
transmit, to the second wireless device, a data signal based at least in part on the one or more power amplifier coefficients for the power amplifier.

2. The first wireless device of claim 1, wherein the one or more processors are individually or collectively further operable to execute the code to cause the first wireless device to:
receive, from the second wireless device, a capability report indicating that the second wireless device is capable of performing an enhanced non-linearity correction, the statistical attribute report is transmitted based at least in part on the capability report.

3. The first wireless device of claim 1, wherein, to transmit the statistical attribute report, the one or more processors are individually or collectively operable to execute the code to cause the first wireless device to:
transmit the statistical attribute report in accordance with a quantity of antennas at the first wireless device, wherein the one or more statistical attributes comprise a quantity of statistical attributes that is based at least in part on the quantity of antennas.

4. The first wireless device of claim 1, wherein, to transmit the statistical attribute report, the one or more processors are individually or collectively operable to execute the code to cause the first wireless device to:
transmit, in the statistical attribute report, one or more second statistical attributes associated with one or more second power amplifier coefficients for a second power amplifier of the first wireless device.

5. The first wireless device of claim 4, wherein:
the power amplifier corresponds to a first transmit chain and the second power amplifier corresponds to a second transmit chain.

6. The first wireless device of claim 1, wherein:
the power amplifier corresponds to a portion of a plurality of antennas of the first wireless device.

7. The first wireless device of claim 1, wherein the one or more statistical attributes comprise a mean associated with the one or more power amplifier coefficients and a variance associated with the one or more power amplifier coefficients.

8. The first wireless device of claim 1, wherein the one or more processors are individually or collectively further operable to execute the code to cause the first wireless device to:
establish a connection with the second wireless device, wherein transmitting the statistical attribute report is based at least in part on establishing the connection.

9. The first wireless device of claim 1, wherein the one or more processors are individually or collectively further operable to execute the code to cause the first wireless device to:
determine the one or more statistical attributes associated with the one or more power amplifier coefficients for the power amplifier of the first wireless device.

10. The first wireless device of claim 1, wherein, to transmit the statistical attribute report, the one or more processors are individually or collectively operable to execute the code to cause the first wireless device to:
transmit the statistical attribute report via a medium access control-control element (MAC-CE), a radio resource control (RRC) message, a physical downlink control channel (PDCCH), a physical downlink shared channel (PDSCH), or a combination thereof.

11. A second wireless device, comprising:
one or more memories storing processor-executable code; and
one or more processors coupled with the one or more memories and individually or collectively operable to execute the code to cause the second wireless device to:
transmit, to a first wireless device, a request for a statistical attribute report associated with a power amplifier of the first wireless device;
receive, in response to the request, the statistical attribute report from the first wireless device, wherein the statistical attribute report comprises one or more statistical attributes associated with one or more power amplifier coefficients for the power amplifier;
receive, from the first wireless device, a data signal based at least in part on the one or more power amplifier coefficients for the power amplifier; and
perform, based at least in part on the statistical attribute report and the data signal, an enhanced non-linearity correction procedure on the data signal.

12. The second wireless device of claim 11, wherein the one or more processors are individually or collectively further operable to execute the code to cause the second wireless device to:
transmit, to the first wireless device, a capability report indicating that the second wireless device is capable of performing an enhanced non-linearity correction, the statistical attribute report is received based at least in part on the capability report.

13. The second wireless device of claim 11, wherein, to perform the enhanced non-linearity correction procedure, the one or more processors are individually or collectively operable to execute the code to cause the second wireless device to:
perform the enhanced non-linearity correction procedure according to a periodicity associated with a period.

14. The second wireless device of claim 13, wherein, to perform the enhanced non-linearity correction procedure, the one or more processors are individually or collectively operable to execute the code to cause the second wireless device to:
perform the enhanced non-linearity correction procedure for a first slot in the period.

15. The second wireless device of claim 14, wherein, to perform the enhanced non-linearity correction procedure for the first slot in the period, the one or more processors are individually or collectively operable to execute the code to cause the second wireless device to:
apply a result of the enhanced non-linearity correction procedure for the first slot in the period to a set of remaining slots in the period.

16. The second wireless device of claim 11, wherein:
the enhanced non-linearity correction procedure is based at least in part on linear minimum mean square error (LMMSE).

17. The second wireless device of claim 11, wherein the enhanced non-linearity correction procedure is a digital post-distortion correction.

18. The second wireless device of claim 11, wherein, to receive the statistical attribute report, the one or more processors are individually or collectively operable to execute the code to cause the second wireless device to:
receive the statistical attribute report in accordance with a quantity of antennas at the first wireless device, wherein the one or more statistical attributes comprise a quantity of statistical attributes that is based at least in part on the quantity of antennas.

19. The second wireless device of claim 11, wherein the one or more statistical attributes comprises a mean associated with the one or more power amplifier coefficients and a variance associated with the one or more power amplifier coefficients.

20. The second wireless device of claim 11, wherein the one or more processors are individually or collectively further operable to execute the code to cause the second wireless device to:
establish a connection with the first wireless device, wherein receiving the statistical attribute report is based at least in part on establishing the connection.

21. The second wireless device of claim 11, wherein, to receive the statistical attribute report, the one or more processors are individually or collectively operable to execute the code to cause the second wireless device to:
receive the statistical attribute report via a medium access control-control element (MAC-CE), a radio resource control (RRC) message, a physical downlink control channel (PDCCH), a physical downlink shared channel (PDSCH), or a combination thereof.

22. A method for wireless communications at a first wireless device, comprising:
receiving, from a second wireless device, a request for a statistical attribute report associated with a power amplifier of the first wireless device;
transmitting, in response to the request, the statistical attribute report to the second wireless device, wherein the statistical attribute report comprises one or more statistical attributes associated with one or more power amplifier coefficients for the power amplifier of the first wireless device; and
transmitting, to the second wireless device, a data signal based at least in part on the one or more power amplifier coefficients for the power amplifier.

23. A method for wireless communications at a second wireless device, comprising:
transmitting, to a first wireless device, a request for a statistical attribute report associated with a power amplifier of the first wireless device;
receiving, in response to the request, the statistical attribute report from the first wireless device, wherein the statistical attribute report comprises one or more statistical attributes associated with one or more power amplifier coefficients for the power amplifier;
receiving, from the first wireless device, a data signal based at least in part on the one or more power amplifier coefficients for the power amplifier; and
performing, based at least in part on the statistical attribute report and the data signal, an enhanced non-linearity correction procedure on the data signal.

24. The method of claim 23, further comprising:
transmitting, to the first wireless device, a capability report indicating that the second wireless device is capable of performing an enhanced non-linearity correction, the statistical attribute report is received based at least in part on the capability report.

25. The method of claim 23, wherein performing the enhanced non-linearity correction procedure comprises:
performing the enhanced non-linearity correction procedure according to a periodicity associated with a period.

26. The method of claim 25, wherein performing the enhanced non-linearity correction procedure comprises:
performing the enhanced non-linearity correction procedure for a first slot in the period.

27. The method of claim 26, wherein performing the enhanced non-linearity correction procedure for the first slot in the period comprises:
applying a result of the enhanced non-linearity correction procedure for the first slot in the period to a set of remaining slots in the period.

28. The method of claim 23, wherein the enhanced non-linearity correction procedure is based at least in part on linear minimum mean square error (LMMSE).

29. The method of claim 23, wherein the enhanced non-linearity correction procedure is a digital post-distortion correction.

30. The method of claim 23, wherein receiving the statistical attribute report comprises:
receiving the statistical attribute report in accordance with a quantity of antennas at the first wireless device, wherein the one or more statistical attributes comprise a quantity of statistical attributes that is based at least in part on the quantity of antennas.
